(19) United States
(12) Patent Application Publication
(10) Pub. No.: US 2010/0212489 A1
(43) Pub. Date: Aug. 26, 2010

(54) REGULATION STRUCTURE FOR A HYDRAULIC CYLINDER UNIT WITH CASCADE STATUS REGULATOR

(76) Inventors: Wilfried Tautz, Forchheim (DE); Dietrich Wohld, Rauschenberg (DE)

Correspondence Address: King & Spalding LLP, 401 Congress Avenue, Suite 3200, Austin, TX, 78701, US

(21) Appl. No.: 12/738,464

(22) PCT Filed: Sep. 5, 2008
(86) PCT No.: PCT/EP2008/061797

§ 371 Date: Apr. 16, 2010

(30) Foreign Application Priority Data
Oct. 24, 2007 (DE) 10 2007 050 892.3

(51) Int. Cl. F15B 13/16

(52) U.S. Cl. 91/361

(57) ABSTRACT

A regulation structure (13) for regulating a hydraulic cylinder unit (1) has an internal regulator (15) and an external regulator (16). The external regulator is supplied with a set force (F*) or a set position (s*) for a piston (3) of the hydraulic cylinder unit and a corresponding actual parameter (F, s) for the piston. The external regulator determines a set status (z*) for the hydraulic cylinder unit and provides the same to the internal regulator as the set value therefor. The regulator structure comprises a status determining unit (19), provided with both an actual position (s) and an actual force (F) for the piston and which determines an actual status (z) for the hydraulic cylinder unit and provides the same to the internal regulator as the actual value therefor. The internal regulator determines a control parameter (u) for a valve control unit (9) of the hydraulic cylinder unit (1).

### CROSS-REFERENCE TO RELATED APPLICATIONS

This application is a U.S. National Stage Application of International Application No. PCT/EP2008/061797 filed Sep. 5, 2008, which designates the United States of America, and claims priority to German Application No. 10 2007 050 892.3 filed Oct. 24, 2007, the contents of which are hereby incorporated by reference in their entirety.

### TECHNICAL FIELD

The present invention is based on a controller structure for controlling a hydraulic cylinder unit,
wherein the controller structure has an external controller, to which a setpoint force or a setpoint position of a piston of the hydraulic cylinder unit is fed as a setpoint value, and to which a corresponding actual variable of the piston is fed,
wherein the external controller determines, on the basis of the setpoint value fed thereto and the actual value fed thereto, a manipulated variable for a valve control unit of the hydraulic cylinder unit and outputs the manipulated variable to the valve control unit.

### BACKGROUND

Such control structures are generally known.

When controlling hydraulic systems which are composed of a servovalve (=valve control unit), hydraulic cylinder and hydraulic piston, the shortest possible activation times are aimed at in order to be able to react quickly when implementing newly predefined setpoint values and compensating for disruption. However, in customary position controllers and force controllers, only relatively long activation times may be possible depending on the behavior of the hydraulic cylinder unit. This problem is highly significant, in particular in the case of long stroke cylinders.

In the prior art an attempt is made to reduce the activation times by applying a force. The application of the force consists in the fact that during the position control the force is connected in a positive feedback arrangement via a DT₁ element. This procedure allows the effective amplification of the position controller to be increased. The activation time therefore becomes shorter. However, a disadvantage with this configuration is that damping of the control process becomes very small. The system therefore tends to oscillate.

DE 10 2006 028 094 A1 discloses, in conjunction with an injection molding machine, a control structure for controlling a hydraulic cylinder unit which has an internal controller and an external controller which is superimposed on the internal controller. A setpoint position of the piston of the hydraulic cylinder unit can be fed as a setpoint value to the external controller, and the corresponding actual variable of the piston can be fed as an actual value to the external controller. The external controller determines, on the basis of the setpoint value fed thereto and on the basis of the actual value fed thereto, a “setpoint state” of the hydraulic cylinder unit. The setpoint state is here the setpoint force. The external controller feeds the setpoint force determined thereby to the internal controller as the setpoint value of said internal controller. Furthermore, the actual force is always fed to the internal controller. In addition, a travel actual value or speed actual value can be fed to the internal controller.

### SUMMARY

According to various embodiments, a controller structure for a hydraulic cylinder unit can be provided which, on the one hand, reacts very dynamically and nevertheless operates in a stable fashion.

According to an embodiment, a controller structure for controlling a hydraulic cylinder unit may comprise an internal controller and an external controller superimposed on the internal controller, wherein a setpoint force or a setpoint position of a piston of the hydraulic cylinder unit is fed as a setpoint value to the external controller, and a corresponding actual variable of the piston is fed as an actual value to the external controller, wherein the external controller determines, on the basis of the setpoint value fed thereto and the actual value fed thereto, a setpoint state of the hydraulic cylinder unit, wherein the external controller feeds the setpoint state, determined thereby, to the internal controller as the setpoint value of said internal controller, wherein the controller structure has a state-determining unit, to which both an actual position of the piston and an actual force of the piston are fed, wherein the state-determining unit determines, on the basis of the actual position, fed thereto, of the piston and the actual force, fed thereto, of the piston as such, an actual state of the hydraulic cylinder unit and feeds said actual state to the internal controller as the actual value thereof, and wherein the internal controller determines, on the basis of the setpoint value fed thereto and the actual value fed thereto, a manipulated variable for a valve control unit of the hydraulic cylinder unit and outputs said manipulated variable to the valve control unit.

According to a further embodiment, the external controller can be embodied as a PI controller. According to a further embodiment, the PI controller may have a proportional block and an integral extension block, which is arranged downstream of the proportional block and extends a proportional signal, output by the proportional block, by an integral portion. According to a further embodiment, a first switching element can be arranged between the proportional block and the integral extension block, a second switching element can be arranged downstream of the internal controller, and the controller structure may have an actuation unit, by which the two switching elements can be actuated, so that the integral extension block and the internal controller can be bypassed by corresponding actuation of the switching elements. According to a further embodiment, the internal controller can be embodied as a P controller. According to a further embodiment, a switching device, to which the setpoint force, the actual force, the setpoint position and the actual position of the piston are fed, can be arranged upstream of the external controller, and the controller structure may have an actuation unit, by which the switching device can be actuated in such a way that the setpoint force and the actual force or the setpoint position and the actual position of the piston are alternatively fed to the external controller. According to a further embodiment, the state-determining unit may determine the actual state on the basis of the relationship

z=s+F/c

where z is the actual state of the hydraulic cylinder unit, s is the actual position of the piston, F is the actual force of the piston and c is a spring constant of a hydraulic fluid of the hydraulic cylinder unit. According to a further embodiment, the controller structure can be embodied as a software module.

According to another embodiment, a hydraulic cylinder unit can be used for controlling the positioning of a rolling stand, wherein the hydraulic cylinder is controlled by means of a controller structure as described above.

According to yet another embodiment, an internal structure for a controller structure for controlling a hydraulic cylinder unit, may comprise an integral extension block which extends a proportional signal, fed to the integral extension block, by an integral portion, wherein the proportional signal which is extended by the integral portion corresponds to a setpoint state which is fed to an internal controller of the internal structure as the setpoint value of said internal controller, wherein the internal structure has a state-determining unit to which both an actual position of a piston of the hydraulic cylinder unit and an actual force of the piston are fed, and which determines, on the basis of the actual position, fed thereto, of the piston and the actual force, fed thereto, of the piston as such, an actual state of the hydraulic cylinder unit and feeds said actual state to the internal controller as the actual value thereof, wherein the internal controller determines, on the basis of the setpoint value fed thereto and the actual value fed thereto, a manipulated variable for a valve control unit of the hydraulic cylinder unit and outputs said manipulated variable to the valve control unit, and wherein the internal structure is embodied as an independent unit which can be connected between an output of a P controller, embodied as a force controller or position controller, for the hydraulic cylinder unit and the valve control unit of the hydraulic cylinder unit into a controller structure which is formed by the P controller and the valve control unit, without having to largely adapt the previously existing controller structure beyond the connection of the internal structure.

According to a further embodiment of the internal structure, a first switching element can be arranged upstream of the integral extension block, a second switching element can be arranged downstream of the internal controller, and the internal structure may have an actuation unit, by which the two switching elements can be actuated, so that the integral extension block and the internal controller can be bypassed by correspondingly actuating the switching elements. According to a further embodiment of the internal structure, the internal controller is embodied as a P controller. According to a further embodiment of the internal structure, the state-determining unit may determine the actual state on the basis of the relationship

z=s+F/c,

where z is the actual state of the hydraulic cylinder unit, s is the actual position of the piston, F is the actual force of the piston and c is a spring constant of a hydraulic fluid of the hydraulic cylinder unit. According to a further embodiment of the internal structure, the internal structure can be embodied as a software module.

### BRIEF DESCRIPTION OF THE DRAWINGS

Further advantages and details emerge from the following description of exemplary embodiments in conjunction with the drawings and the further claims. In basic illustration

FIG. 1 shows an overall circuit diagram of a hydraulic cylinder unit and a controller structure,

FIG. 2 shows the controller structure in FIG. 1 in detail, and

FIG. 3 shows an embodiment of the controller structure in FIG. 2.

### DETAILED DESCRIPTION

According to various embodiments, the controller structure has an internal controller and an external controller superimposed on the internal controller. A setpoint force or a setpoint position of a piston of the hydraulic cylinder unit is fed as a setpoint value to the external controller, and a corresponding actual variable of the piston is fed as an actual value to the external controller.

The external controller determines, on the basis of the setpoint value fed thereto and the actual value fed thereto, a setpoint state of the hydraulic cylinder unit. The external controller feeds the setpoint state to the internal controller as the setpoint value of said internal controller. The controller structure also has a state-determining unit, to which both an actual position of the piston and an actual force of the piston are fed. The state-determining unit determines, on the basis of the actual position, fed thereto, of the piston and the actual force, fed thereto, of the piston as such, an actual state of the hydraulic cylinder unit and feeds the actual state to the internal controller as the actual value thereof. The internal controller determines, on the basis of the setpoint value fed thereto and the actual value fed thereto, a manipulated variable for a valve control unit of the hydraulic cylinder unit and outputs the manipulated variable to the valve control unit.

According to various embodiments, the hydraulic control system can be constructed as a cascade control system. A state is calculated from the position of the piston and from the force applied thereby and is controlled in an internal control circuit. The position controller and/or force controller are/is superimposed on the internal control circuit.

Owing to the design according to various embodiments, very good control results are obtained, in particular during position control. To a certain extent, activation times of a few milliseconds (typically less than 30 ms and in some cases even less than 20 ms) can be achieved. The controller structure according to various embodiments is also advantageous for force control. However, despite the improved controller dynamics, the controller structure according to various embodiments does not tend to oscillate.

In one embodiment, the external controller is embodied as a PI controller. This contrasts with the customary embodiment of controller structures for hydraulic cylinder units in which the force controller or position controller is embodied as a P controller.

In a further preferred embodiment, the PI controller has a proportional block and an integral extension block which is arranged downstream of the proportional block. The proportional block outputs a proportional signal which is extended by the integral extension block by an integral portion. Owing to this embodiment, it is in particular easily possible to retrofit an already existing controller structure (add: embodied as a P controller) for controlling a hydraulic cylinder unit, so that the retrofitted controller structure is embodied according to various embodiments.

It is possible that a first switching element is arranged between the proportional block and the integral extension block, and a second switching element is arranged downstream of the internal controller. In this case, the controller structure has an actuation unit, by which the two switching elements can be actuated. In this case, the integral extension block and the internal controller can be bypassed by corresponding actuation of the switching elements. By virtue of this embodiment it is possible to operate the controller structure alternatively in the fashion according to various embodiment(i.e. with two cascaded controllers, with the external controller being embodied as a PI controller) or in a conventional fashion (i.e. as an individual controller which operates as a P controller).

As already mentioned, the external controller is preferably embodied as a PI controller. The internal controller is, on the other hand, preferably embodied as a P controller.

It is possible to arrange upstream of the external controller a switching device to which the setpoint force, the actual force, the setpoint position and the actual position of the piston are fed. In this case, the controller structure has an actuation unit, by which the switching device can be actuated in such a way that the setpoint force and the actual force or the setpoint position and the actual position of the piston are alternatively fed to the external controller. This makes it possible to operate the hydraulic cylinder unit alternatively with force control and position control.

The state-determining unit determines the actual state, preferably on the basis of the relationship

z=s+F/c (1)

where z is the actual state of the hydraulic cylinder unit, s is the actual position of the piston, F is the actual force of the piston and c is a spring constant of a hydraulic fluid of the hydraulic cylinder unit. This procedure produces particularly good controller results.

It is possible for the controller structure to be embodied using hardware. However, it is preferred to embody it as software.

The hydraulic cylinder unit can in principle be used for any desired adjustment processes. However, it is preferred to use a hydraulic cylinder unit, controlled by means of a controller structure according to the invention, to control the positioning of a rolling stand.

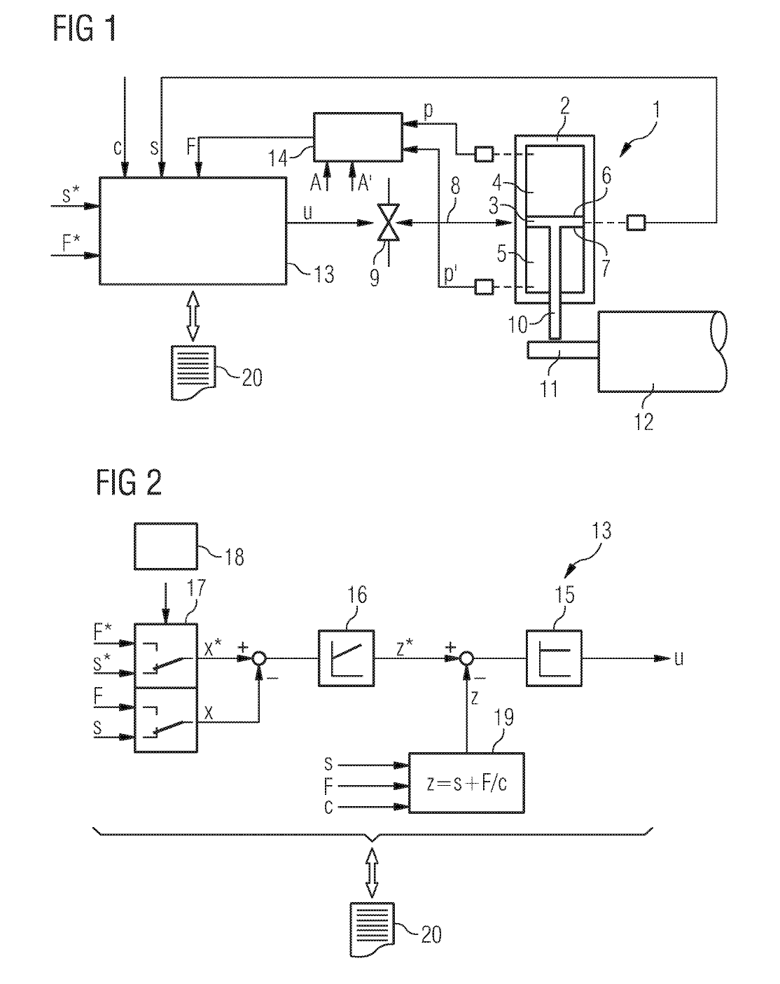

According to FIG. 1, a hydraulic cylinder unit 1 has a hydraulic cylinder 2. In the hydraulic cylinder 2, a piston 3 is mounted in a displaceable fashion. The piston 3 divides two working spaces 4, 5 from one another. It has a first working face A on its front side 6, and a second working face A′ on its rear side 7.

Working pressures p, p′ are provided in the working spaces 4, 5. The feeding in and discharging of a hydraulic fluid 8 are carried out via a valve control unit 9.

The design explained above and the method of operation of the hydraulic cylinder unit 1 and of the valve control unit 9 as briefly explained above are generally known. No detailed statements will therefore be necessary in this regard.

The hydraulic cylinder unit 1 can be used for any desired purposes of use. According to FIG. 1, the piston 3 acts, for example, via a plunger 10 on a bearing 11 of a roller 12 of a rolling stand (otherwise not illustrated). The hydraulic cylinder unit 1 is therefore used in the present case for controlling the positioning of the rolling stand. The hydraulic cylinder unit 1 is controlled according to FIG. 1 by means of a controller structure 13 which outputs a manipulated variable u to the valve control unit 9. An actual position s of the piston 3 and an actual force F which is applied by the piston 3 are fed as actual values s, F to the controller structure 13. The actual force F is determined here according to the formula

F=pA−p′A′ (2).

The determination is carried out according to FIG. 1 in a force-determining unit 14, which is not a component of the controller structure 13. However, the force-determining unit 14 could be integrated into the controller structure 13. Furthermore, at least one setpoint value s*, F* is fed to the controller structure 13. This may alternatively be a setpoint position s* of the piston 3 or a setpoint force F* which is to be applied by the piston 3. It is also possible to feed both setpoint values s*, F* to the controller structure 13. This will be explained in more detail later in relation to FIG. 2.

Finally, a spring constant c of the hydraulic fluid 8 is fed to the controller structure 13 as a parameter. The spring constant c can be an absolute constant here. Alternatively, it can be determined as a function of the actual position s of the piston 3, if appropriate with inclusion of the working pressures p, p′ and of the working faces A, A′.

The embodiment of the controller structure 13 will be explained below in detail in relation to FIG. 2. The embodiment of the controller structure 13 is the core concept of the present invention.

According to FIG. 2, the controller structure 13 has an internal controller 15 and an external controller 16. The external controller 16 is superimposed here on the internal controller 15. The internal controller 15 is preferably embodied as a P controller. The external controller 16 is preferably embodied as a PI controller.

The setpoint force F* or the setpoint position s* is alternatively fed as a setpoint value x* to the external controller 16. The corresponding actual variable s, F of the piston 3 is fed as an actual value x to the external controller 16.

It is possible for a switching device 17 to be arranged upstream of the external controller 16. In this case, the setpoint force F*, the actual force F, the setpoint position s* and the actual position s of the piston 3 are fed to the switching device 17. The controller structure 13 has, in this case, an actuation unit 18, by which the switching device 17 can be actuated. Depending on the actuation state of the switching device 17, the setpoint force F* and the actual force F or the setpoint position s* and the actual position s of the piston 3 are alternatively fed to the external controller 16, in this case. The external controller 16 can therefore alternatively be operated as a force controller or as a position controller.

Irrespective of whether the external controller 16 is operated as a force controller or as a position controller, the external controller 16 determines, on the basis of the setpoint value x* fed thereto and the actual value x fed thereto, a setpoint state z* of the hydraulic cylinder unit 1. The external controller 16 feeds the setpoint state z* determined thereby to the internal controller 15 as the setpoint value z* thereof.

The controller structure 13 also has a state-determining unit 19. Both the actual position s and the actual force F of the piston 3 are fed to the state-determining unit 19. The state-determining unit 19 determines, on the basis of the values s, F fed thereto, an actual state z of the hydraulic cylinder unit 1. The state-determining unit 19 feeds the actual state z determined thereby to the internal controller 15 as actual value z thereof.

It is possible that the state-determining unit 19 determines the actual state z exclusively on the basis of the actual position s and the actual force F. As a rule, the spring constant c is, however, additionally fed to the state-determining unit 19. In this case, the state-determining unit 19 preferably determines the actual state z on the basis of the relationship

z=s+F/c (3).

The actual state z therefore corresponds, from the outset to a quantity of hydraulic fluid 8 which is located in the hydraulic cylinder unit 1.

The internal controller 15 determines, on the basis of the setpoint value z* fed thereto and the actual value z fed thereto, the manipulated variable u for the valve control unit 9 and outputs the manipulated variable u to the valve control unit 9.

It is possible for the controller structure 13 to be implemented by means of circuitry. The controller structure 13 is, however, preferably embodied as a software module 20 according to FIGS. 1 and 2.

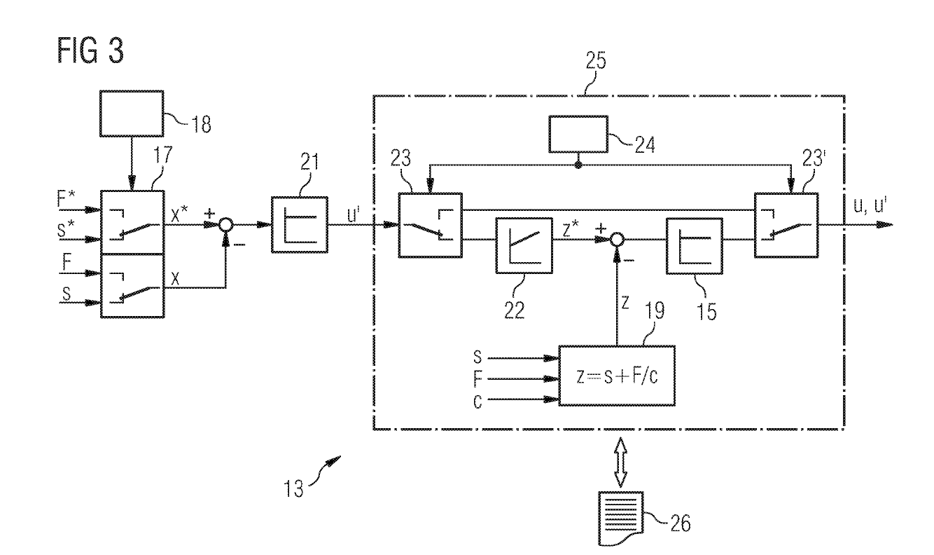

A modification of the controller structure 13 in FIG. 2 will be explained below in relation to FIG. 3. In so far as it is possible and appropriate, the same reference symbols as those in FIG. 2 are used here. In addition, only the differences are emphasized below. The other statements regarding the design and method of functioning of the controller structure 13 largely remain valid.

According to FIG. 3, the external controller 16 has a proportional block 21 and an integral extension block 22. The integral extension block 22 is arranged downstream of the proportional block 21 here. The proportional block 21 outputs a proportional signal u′. The proportional block 21 therefore corresponds, from the outset, to P controller. The integral extension block 22 extends the proportional signal u′ output by the proportional block 21 by an integral portion. The combination of the proportional block 21 and the integral extension block 22 therefore corresponds to the external controller 16 embodied as a PI controller 16.

According to FIG. 3, a first switching element 23 is arranged between the proportional block 21 and the integral extension block 22. Furthermore, a second switching element 23′ is arranged downstream of the internal controller 15. In this case, the controller structure 13 also has an actuation unit 24, by which the two switching elements 23, 23′ can be actuated. Depending on the actuation state of the switching elements 23, 23′ the integral extension block 22 and the internal controller 15 are therefore alternatively active or inactive. Depending on the actuation state of the switching elements 23, 23′ the controller structure 13 can therefore be operated either as a conventional force controller or position controller or as a cascaded controller according to various embodiments. In the first-mentioned case, the conventional controller is embodied here as P controller, and in the last-mentioned case the external controller 16 is embodied as a PI controller, and the internal controller 15 as P controller.

The actuation unit 24 is illustrated in FIG. 3 as a device which is independent of the actuation unit 18. This embodiment is, of course, possible. Alternatively, the actuation units 18, 24 can be combined to form a common unit.

The integral extension block 22, the internal controller 15 and the state-determining unit 19 together form an internal structure 25 of the controller structure 13. The internal structure 25 can be embodied as an independent unit. In particular, according to FIG. 3, it is possible, when the controller structure 13 is embodied as a software module 20, for said internal structure 25 to be embodied as a separate software module 26. The switching elements 23, 23′ and the actuation unit 24 for the switching elements 23, 23′ may here be components of the internal structure 25. However, they can alternatively not be present or be arranged outside the internal structure 25.

Owing to the controller structure 13 which is configured according to various embodiments, shorter actuation times (in some cases below 20 ms, for example 15 ms), than with conventionally configured controller structures can be achieved. This applies even if the conventional controller is operated as a position controller with force-application means. Nevertheless, in the controller structure 13 according to various embodiments the damping is larger, that is to say the tendency to oscillate is smaller.

In the embodiment according to FIG. 3, the internal structure 25 can be implemented as an independent block. This embodiment permits, on the one hand, simple retrofitability of existing conventional controller structures. On the other hand, this embodiment makes it possible to alternatively connect to the internal structure 25 or bypass it. There is no need for more wide-ranging adaptation of superimposed controller structures here.

The above description serves exclusively to explain the present invention. On the other hand, the scope of protection of the present invention is to be determined exclusively by the appended claims.

What is claimed is:

1. A controller structure for controlling a hydraulic cylinder unit, comprising
an internal controller and an external controller superimposed on the internal controller,
wherein a setpoint force or a setpoint position of a piston of the hydraulic cylinder unit is fed as a setpoint value to the external controller, and a corresponding actual variable of the piston is fed as an actual value to the external controller,
wherein the external controller is operable to determine, on the basis of the setpoint value fed thereto and the actual value fed thereto, a setpoint state of the hydraulic cylinder unit,
wherein the external controller is operable to feed the setpoint state, determined thereby, to the internal controller as the setpoint value of said internal controller,
a state-determining unit, to which both an actual position of the piston and an actual force of the piston are fed,
wherein the state-determining unit is operable to determines, on the basis of the actual position, fed thereto, of the piston and the actual force, fed thereto, of the piston as such, an actual state of the hydraulic cylinder unit and feeds said actual state to the internal controller as the actual value thereof, and
wherein the internal controller is operable to determine, on the basis of the setpoint value fed thereto and the actual value fed thereto, a manipulated variable for a valve control unit of the hydraulic cylinder unit and outputs said manipulated variable to the valve control unit.

2. The controller structure according to claim 1, wherein the external controller is embodied as a PI controller.

3. The controller structure according to claim 2, wherein the PI controller has a proportional block and an integral extension block, which is arranged downstream of the proportional block and extends a proportional signal, output by the proportional block, by an integral portion.

4. The controller structure according to claim 3, wherein a first switching element is arranged between the proportional block and the integral extension block, in that a second switching element is arranged downstream of the internal controller, and wherein the controller structure has an actuation unit, by which the two switching elements can be actuated, so that the integral extension block and the internal controller can be bypassed by corresponding actuation of the switching elements.

5. The controller structure according to claim 1, wherein the internal controller is embodied as a P controller.

6. The controller structure according to claim 1, wherein a switching device, to which the setpoint force, the actual force, the setpoint position and the actual position of the piston are fed, is arranged upstream of the external controller, and wherein the controller structure has an actuation unit, by which the switching device can be actuated in such a way that the setpoint force and the actual force or the setpoint position and the actual position of the piston are alternatively fed to the external controller.

7. The controller structure according to claim 1, wherein the state-determining unit determines the actual state on the basis of the relationship
z=s+F/c
where z is the actual state of the hydraulic cylinder unit, s is the actual position of the piston, F is the actual force of the piston and c is a spring constant of a hydraulic fluid of the hydraulic cylinder unit.

8. The controller structure according to claim 1, wherein said controller structure is embodied as a software module.

9. A method for using of a hydraulic cylinder unit, comprising the step of using a hydraulic cylinder unit controlled by means of a controller structure according to claim 1, for controlling the positioning of a rolling stand.

10. An internal structure for a controller structure for controlling a hydraulic cylinder unit, comprising
an integral extension block which extends a proportional signal, fed to the integral extension block, by an integral portion,
wherein the proportional signal which is extended by the integral portion corresponds to a setpoint state which is fed to an internal controller of the internal structure as the setpoint value of said internal controller,
a state-determining unit to which both an actual position of a piston of the hydraulic cylinder unit and an actual force of the piston are fed, and which determines, on the basis of the actual position, fed thereto, of the piston and the actual force, fed thereto, of the piston as such, an actual state of the hydraulic cylinder unit and feeds said actual state to the internal controller as the actual value thereof,
wherein the internal controller determines, on the basis of the setpoint value fed thereto and the actual value fed thereto, a manipulated variable for a valve control unit of the hydraulic cylinder unit and outputs said manipulated variable to the valve control unit, and
wherein the internal structure is embodied as an independent unit which can be connected between an output of a P controller, embodied as a force controller or position controller, for the hydraulic cylinder unit and the valve control unit of the hydraulic cylinder unit into a controller structure which is formed by the P controller and the valve control unit, without having to largely adapt the previously existing controller structure beyond the connection of the internal structure.

11. The internal structure according to claim 10, wherein a first switching element is arranged upstream of the integral extension block, in that a second switching element is arranged downstream of the internal controller, and in that the internal structure has an actuation unit, by which the two switching elements can be actuated, so that the integral extension block and the internal controller can be bypassed by correspondingly actuating the switching elements.

12. The internal structure according to claim 10, wherein the internal controller is embodied as a P controller.

13. The internal structure according to claim 10, wherein the state-determining unit determines the actual state on the basis of the relationship
z=s+F/c,
where z is the actual state of the hydraulic cylinder unit, s is the actual position of the piston, F is the actual force of the piston and c is a spring constant of a hydraulic fluid of the hydraulic cylinder unit.

14. The internal structure according to claim 10, wherein said internal structure is embodied as a software module.

15. The method according to claim 9, wherein the external controller is embodied as a PI controller.

16. The method according to claim 9, wherein the PI controller has a proportional block and an integral extension block, which is arranged downstream of the proportional block and extends a proportional signal, output by the proportional block, by an integral portion.

17. The method according to claim 16,
wherein a first switching element is arranged between the proportional block and the integral extension block, in that a second switching element is arranged downstream of the internal controller, and wherein the controller structure has an actuation unit, by which the two switching elements can be actuated, so that the integral extension block and the internal controller can be bypassed by corresponding actuation of the switching elements.

18. The method according to claim 9, wherein the internal controller is embodied as a P controller.

19. The method according to claim 9, wherein a switching device, to which the setpoint force, the actual force, the setpoint position and the actual position of the piston are fed, is arranged upstream of the external controller, and wherein the controller structure has an actuation unit, by which the switching device can be actuated in such a way that the setpoint force and the actual force or the setpoint position and the actual position of the piston are alternatively fed to the external controller.

20. The method according to claim 9, wherein the state-determining unit determines the actual state on the basis of the relationship
z=s+F/c
where z is the actual state of the hydraulic cylinder unit, s is the actual position of the piston, F is the actual force of the piston and c is a spring constant of a hydraulic fluid of the hydraulic cylinder unit.
